(19) United States
(12) Patent Application Publication
(10) Pub. No.: US 2026/0287098 A1
(43) Pub. Date: Sep. 24, 2026

(54) FITTING

(71) Applicant: GEBERIT INTERNATIONAL AG, Jona (CH)

(72) Inventor: Matthias HOLZINGER, Wolfhausen (CH)

(73) Assignee: GEBERIT INTERNATIONAL AG, Jona (CH)

(21) Appl. No.: 19/475,616

(22) PCT Filed: Mar. 26, 2024
(86) PCT No.: PCT/EP2024/058089

§ 371 Date: Oct. 15, 2025

(30) Foreign Application Priority Data
Apr. 17, 2023 (EP) 23168215.4

(51) Int. Cl. F16L 21/08; F16L 25/14; F16L 35/00

(52) U.S. Cl. CPC F16L 21/08; F16L 25/14; F16L 35/005

(57) ABSTRACT

A fitting to connect a hose to a filling valve including: a fitting member having a side wall delimiting a throughflow channel which extends from an inlet to an outlet, and having a first coupling portion for connecting the fitting member to the hose and having a second coupling portion for connecting the fitting member to the filling valve, and a nozzle element which protrudes with a nozzle portion from the inlet or from the outlet into the throughflow channel. The nozzle element has a nozzle-element-side connection portion and the fitting member has a fitting-member-side connection portion, wherein the two connection portions can be mechanically brought into engagement with each other to connect the nozzle element to the fitting member.

### TECHNICAL FIELD

The present invention relates to a fitting according to claim 1, a fitting arrangement according to claim 13, a cistern arrangement according to claim 15 and a method according to claim 16.

### PRIOR ART

Fittings for connecting a hose to a filling valve are known from the prior art. For example, EP 1 292 736 discloses a fitting in the form of a connection nipple via which a filling valve can be connected to a supply line.

### SUMMARY OF THE INVENTION

Based on this prior art, an object of the invention is to provide a fitting with improved properties. In particular, a fitting which is simple to handle during an assembly operation is intended to be provided.

This objective and other objectives are solved by the subject-matter of claim 1. Accordingly, a fitting for the connection of a hose to a filling valve comprises a fitting member and a nozzle element. The fitting member has a side wall which laterally delimits a throughflow channel which extends from an inlet to an outlet along a centre axis. Furthermore, the fitting member has a first coupling portion for connecting the fitting member to the hose and a second coupling portion for connecting the fitting member to the filling valve. The nozzle element protrudes with a nozzle portion from the inlet or from the outlet into the throughflow channel. The nozzle element has a nozzle-element-side connection portion and the fitting member has a fitting-member-side connection portion. The two connection portions can be mechanically brought into engagement with each other in such a manner that the nozzle element is connected to the fitting member when a mechanical engagement is produced.

The connection between the nozzle element and the fitting member has the advantage that, during the assembly and disassembly of the fitting member with a connected hose to the filling valve, the nozzle element cannot fall out of the fitting member. The assembly is typically carried out inside a cistern with very constricted spatial relationships, where a fitter can usually carry out assembly manipulation operations using only one hand. As a result of the connection between the nozzle element and the fitting member, the assembly is significantly simplified. In particular, the nozzle element cannot fall freely into the cistern during assembly or disassembly operations.

The term “mechanical engagement” is in particular intended to be understood to mean a positive-locking and/or non-positive-locking engagement.

The nozzle element is preferably inserted into the nozzle channel via the outlet.

In a variant, the engagement is such that the nozzle element is connected to the fitting member in a manner fixed in position with respect to a movement in the direction of the centre axis. In this variant, the fitting member may also be connected to the fitting member in a manner fixed in position with respect to a movement about the centre axis.

In another variant, the engagement is such that the nozzle element is connected to the fitting member in a movable manner with respect to a movement in the direction of the centre axis and with respect to a movement about the centre axis. In other words, the nozzle element is secured with respect to a movement in the direction of the centre axis and can move freely about the centre axis. This has the advantage that the nozzle element can be connected to the fitting member without rotation orientation.

Preferably, the engagement is such that it counteracts an extraction force acting on the nozzle element.

Preferably, the connection portions are located outside the throughflow channel. This has the advantage that the throughflow of the water through the throughflow channel is not disturbed by the connection portions. The function of fixing the nozzle element is consequently uncoupled with respect to the function of the water throughflow.

Preferably, the connection portions are configured in such a manner that the engagement can be provided by means of a locking connection.

Preferably, the nozzle-element-side connection portion has at least one locking flap and the fitting-member-side connection portion has at least one locking recess, wherein the at least one locking flap engages in the at least one locking recess. Alternatively or additionally, the nozzle-element-side connection portion has at least one locking recess and the fitting-member-side connection portion has at least one locking flap, wherein the at least one locking flap engages in the at least one locking recess.

Preferably, the locking recess is in the form of a groove which extends completely or partially around the centre axis. Preferably, the at least one locking flap has a locking cam. Preferably, the at least one locking flap is orientated substantially parallel with the nozzle portion.

Preferably, at least three, in particular at least four, in a particularly preferred manner precisely four locking flaps are arranged.

Preferably, when a plurality of locking flaps are present, the locking flaps are arranged in a state distributed with regular spacing from each other about the centre axis.

Preferably, the cross section of the at least one locking flap becomes smaller as the distance from the free end of the respective locking flap becomes smaller.

Preferably, the nozzle-element-side connection portion has a flange which protrudes away in a state inclined in an angled manner, in particular substantially at right-angles, with respect to the nozzle portion. Preferably, the at least one locking flap protrudes away from the flange. That is to say, the at least one locking flap is formed on the flange.

Preferably, the flange extends substantially completely around the centre axis. However, it is also conceivable for the flange to extend only partially around the centre axis.

Preferably, the flange has on the outer side a bearing face which extends cylindrically, in particular in a circular-cylindrical manner about the centre axis. The bearing face may come into contact with a correspondingly formed bearing face on a filling valve. Preferably, the bearing face, when viewed in the direction of the centre axis, is configured to be very slim. In particular, when viewed in the direction of the centre axis, the bearing face has an extent in the range from 0.2 to 0.8 millimetre.

Preferably, the nozzle element has at the front a stop face which is located outside the throughflow channel and which can come into contact with a correspondingly formed stop face on a filling valve.

Preferably, the side wall of the fitting member is configured in the region of the fitting-member-side connection location at the outer side with a cylindrical cross section, wherein the at least one locking flap is located at the outer side with respect to the cylindrical cross section and wherein the locking recesses extend into the cylindrical cross section.

The cylindrical cross section is preferably circular.

In place of the locking connection, in other embodiments it is possible for the engagement to be provided by means of a bayonet connection or a screw connection. The two connection portions are in this instance constructed accordingly.

Preferably, the nozzle portion has at least two guiding walls which subdivide the throughflow channel into a plurality of part-channels. The cross section of the throughflow channel is reduced by the cross section of the guiding walls.

Preferably, the guiding walls have a length which is at least five times the cross section of the throughflow channel with a nozzle element not inserted.

In a particularly preferred manner, the guiding walls divide the throughflow channel into four part-channels.

Preferably, the cross sectional surface-area of the part-channels remains constant as far as possible over the complete length.

Preferably, the cross sectional surface-area of all part-channels corresponds by a factor in the range from 10 to 50 times smaller than the cross sectional surface-area of the throughflow channel with the nozzle element not inserted.

Preferably, the flange has a plurality of passages, wherein the guiding walls extend away from the flange in such a manner that the passages remain free.

That is to say, the guiding walls are located outside the clear width of the passages.

A fitting arrangement comprises a fitting according to the above description and a hose, wherein the hose is connected, in particular securely, to the first coupling portion. The hose has a flexible hose cover which is surrounded at the outer side by an optional protective cover, in particular by a protective mesh, preferably by a metal mesh.

Preferably the first coupling portion has a large number of grooves or projections which extend around the centre axis, wherein the flexible hose cover penetrates into the grooves or the projections penetrate into the flexible hose cover.

Preferably, the hose has a cylindrical pressing element which surrounds the hose cover and when the protective cover is present also surrounds the protective cover at the outer side, and which for fixed connection of the hose to the first coupling portion is pressed securely against the first coupling portion.

A cistern arrangement comprises a cistern, a filling valve which is arranged in the cistern and a fitting arrangement which is arranged in the cistern according to the above description, wherein the second coupling portion is connected to the filling valve.

A method for assembling the mentioned cistern arrangement is characterized in that, prior to the assembly of the fitting arrangement on the filling valve, the nozzle element with the nozzle-element-side connection portion is brought into engagement with the fitting-member-side connection portion in such a manner that the nozzle element is supported securely on the fitting member.

Further embodiments are set out in the dependent claims.

### BRIEF DESCRIPTION OF THE DRAWINGS

Preferred embodiments of the invention are described below with reference to the drawings which are merely for explanatory purposes and are not intended to be interpreted in a limiting manner. In the drawings:

FIG. 1 shows a perspective exploded view of a fitting arrangement having a fitting according to the invention, a hose and a filling valve;

FIG. 2 shows a sectioned illustration through the fitting arrangement according to FIG. 1;

FIG. 3 shows a detailed view of the detail Ill according to FIG. 2;

FIG. 4a shows a perspective and detailed exploded view of the fitting according to the preceding Figures;

FIG. 4b shows a side view of FIG. 4a with an assembled nozzle element; and

FIG. 5 shows a sectioned illustration transversely through the throughflow channel of the fitting according to the preceding Figures.

### DESCRIPTION OF PREFERRED EMBODIMENTS

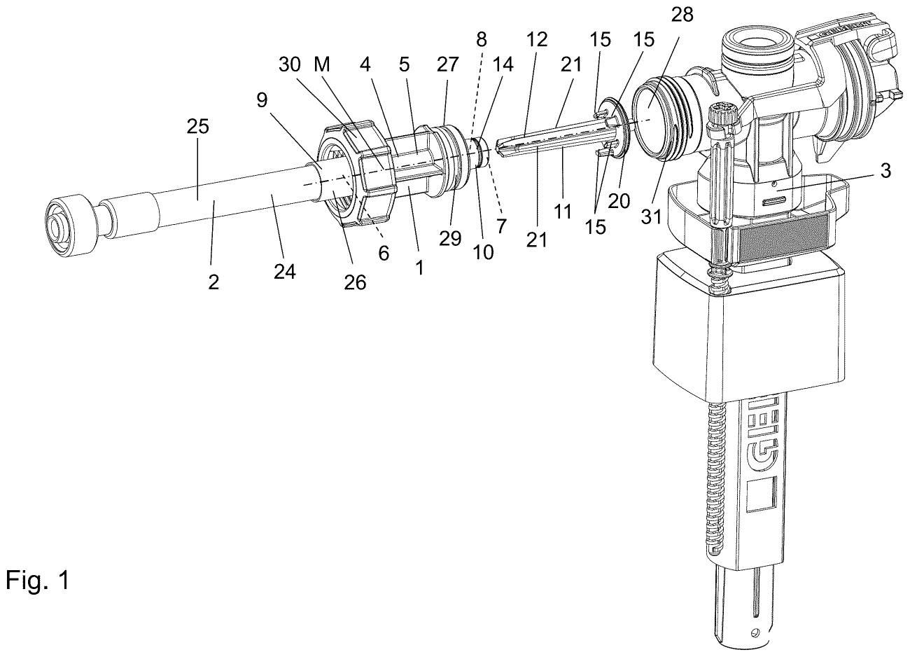

In FIGS. 1 to 5, a fitting arrangement or a fitting or portions thereof is/are shown.

The fitting arrangement according to FIG. 1 comprises a fitting 1, which will be described in detail below and a hose 2 which is securely connected to the fitting 1. The fitting 1 can be connected to a filling valve 3. In other words, the fitting 1 serves to connect the hose 2 to the filling valve 3. With the end of the hose 2 which is opposite the fitting 1, the hose 2 can be connected to a water supply line. When installed in a cistern which is not shown in the Figures, the hose 2 extends through the wall of the cistern. The fitting 1, portions of the hose 2 and filling valve 3 are located in this instance in the cistern, wherein the hose 2 protrudes out of the cistern at least with the mentioned end.

The fitting 1 comprises a fitting member 4 and a nozzle element 11. The fitting member 4 is configured with a side wall 5 which laterally delimits a throughflow channel 8 which extends from an inlet 6 to an outlet 7 along a centre axis M. Furthermore, the fitting member 4 has a first coupling portion 9 for connection of the fitting member 4 to the hose 2 and a second coupling portion 10 for connection of the fitting member 4 to the filling valve 3.

The nozzle element protrudes with a nozzle portion 12 from the outlet 7 of the throughflow channel 8 into the throughflow channel 8. The nozzle element 11 has a nozzle-element-side connection portion 13 and the fitting member 4 has a fitting-member-side connection portion 14. The nozzle portion 12 and the nozzle-element-side connection portion 13 are connected to each other in an integral manner. The two connection portions 13,14 can be brought mechanically into engagement with each other in such a manner that the nozzle element 11 is connected to the fitting member 4 when a mechanical engagement is produced. In the connected state, the nozzle element 11 protrudes with the nozzle portion 12 into the throughflow channel 8.

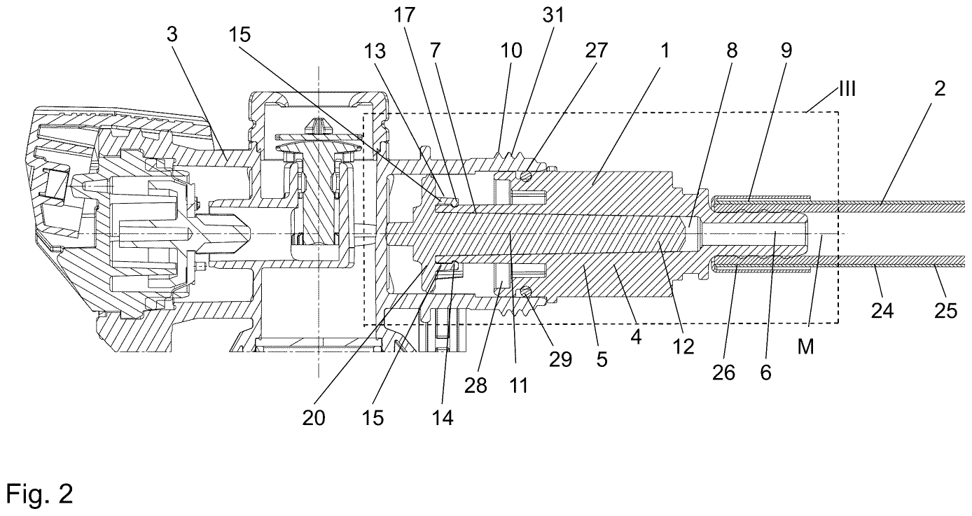

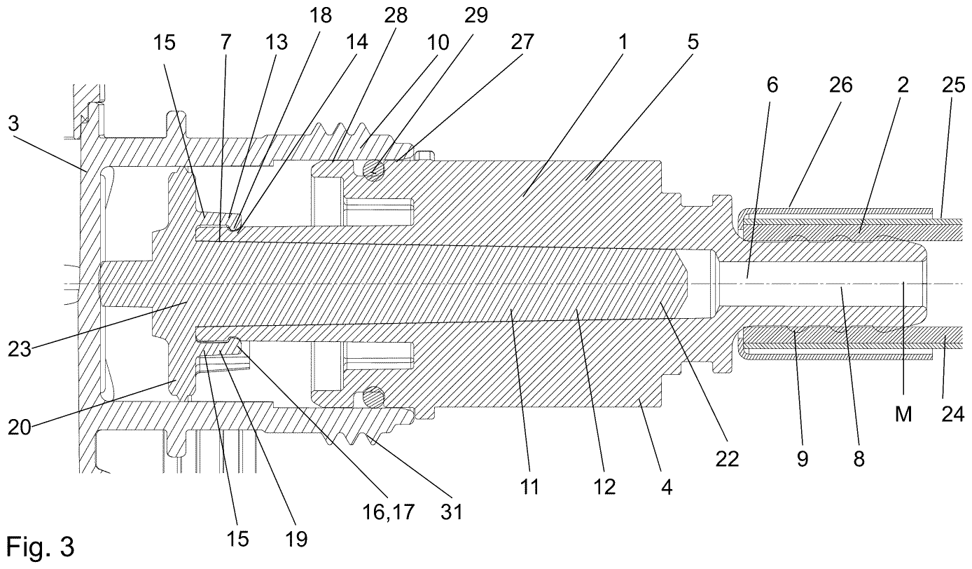

In FIGS. 2 and 3, the protrusion of the nozzle portion 12 and the connection of the two connection portions 13, 14 are shown in greater detail.

With reference to FIGS. 2 to 4, the particularly preferred embodiment is now explained in greater detail.

The engagement between the two connection portions 13,14 is in this instance such that the nozzle element 11 is connected in a manner fixed in position to the fitting member 4 with respect to a movement in in the direction of the centre axis M. Furthermore, the engagement is such that the nozzle element 11 can be rotated about the centre axis M. The engagement is further such that it counteracts an extraction force acting on the nozzle element 11. When the extraction force exceeds a predetermined size, the engagement is preferably cancelled in such a manner that the nozzle element 11 can be separated from the fitting member 4.

In the embodiment shown, both connection portions 13, 14 are located outside the throughflow channel 8. This has the advantage that the mechanical connection via the connection portions 13, 14 is separate from the fluid functions. That is to say, the mechanical connection between the fitting member 4 and the nozzle element 11 does not influence the flow relationships in the throughflow channel 8. In particular, with a corresponding configuration of the nozzle portion 12, a laminar flow in the throughflow channel 8 can also be achieved.

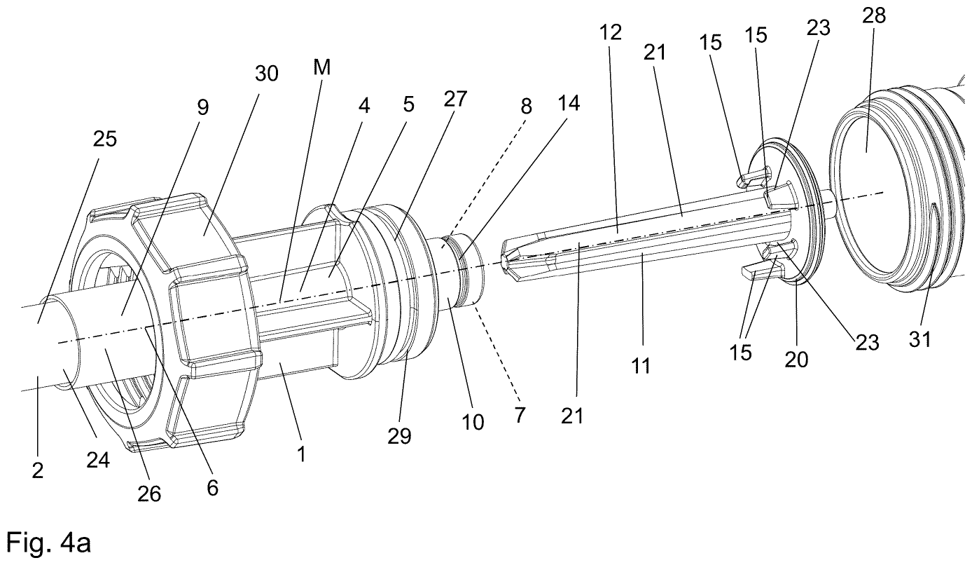

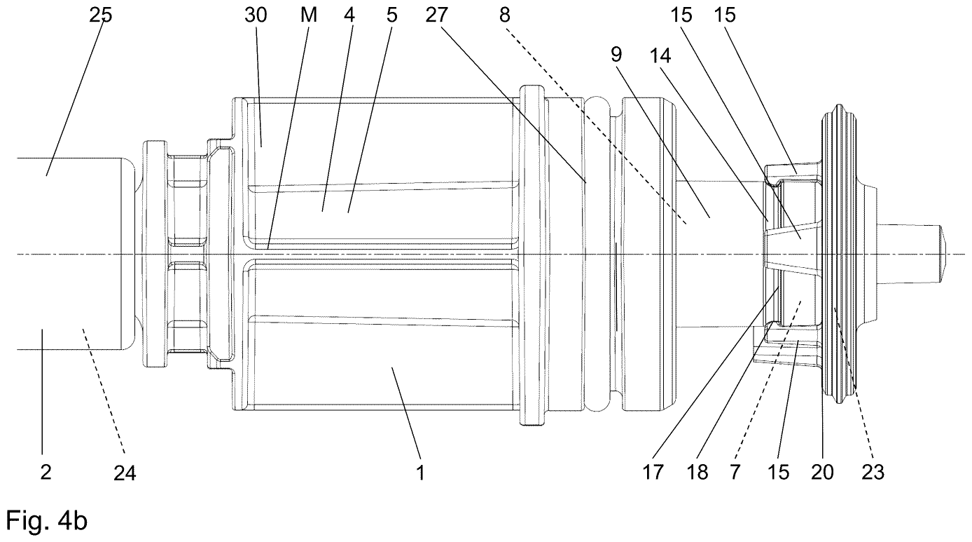

In the embodiment shown, the connection portions 13, 14 are configured in such a manner that the engagement can be provided by means of a locking connection. The nozzle-element-side connection portion 13 has at least one locking flap 15 and the fitting-member-side connection portion 14 has at least one locking recesses 16. The at least one locking flap 15 engages in the at least one locking recess 16. The at least one locking flap 15 and the at least one locking recess 16 are in this instance configured to complement each other in such a manner that the engagement is possible. The engagement can be seen particularly clearly in FIGS. 3 and 4b.

In the embodiment shown, the locking recess 16 is in the form of a groove 17. The groove 17 extends in this instance completely around the centre axis M. In this instance, the groove 17 extends from the outer side into the fitting member 4. The at least one locking flap 15 has at the free end 19 thereof a locking cam 18. The locking cam 18 is configured in such a manner that it can engage in the groove 17 mentioned. The at least one locking flap 15 is orientated substantially parallel with the nozzle portion 12. The cross section of the at least one locking flap becomes smaller as the distance from the free end 19 of the respective locking flap 15 becomes smaller.

In the embodiment shown, four locking flaps 15 are arranged. However, it is also conceivable for more or fewer than four locking flaps 15 to be arranged. The locking flaps 15 are preferably arranged in a state distributed with regular spacing about the centre axis M.

In the embodiment shown, the nozzle-element-side connection portion 13 has a flange 20. The flange 20 is inclined in an angled manner, in particular substantially at right-angles with respect to the nozzle portion 12. The at least one locking flap 15 protrudes from the flange and extends substantially in the same direction as the nozzle portion 12. The at least one locking flap 15 is in this instance radially spaced apart from the nozzle portion 12 so that between the nozzle portion 12 and the at least one locking flap 15 a spatial region in which portions of the fitting-member-side connection portion 14 can protrude can be provided.

The side wall 5 of the fitting member 4 in the region of the fitting-member-side connection location 14 is configured at the outer side with a cylindrical cross section. The at least one locking fap 15 is located in this instance at the outer side with respect to the cylindrical cross section, and wherein the locking recesses 16 extend into the cylindrical cross section.

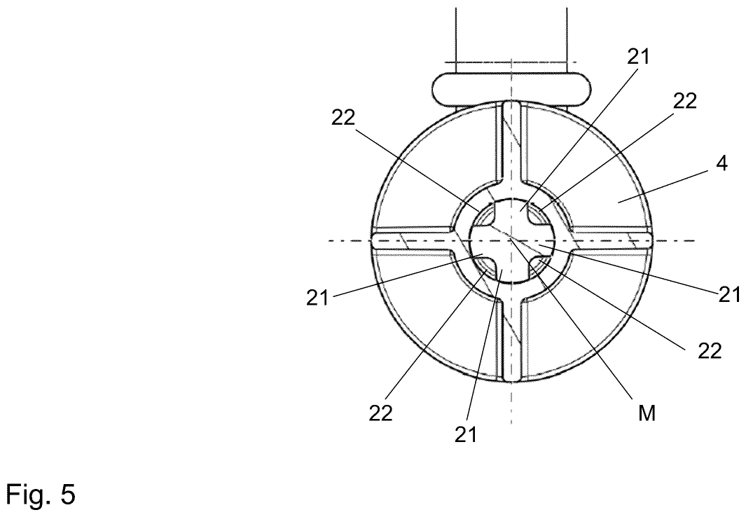

As can be seen in the Figures, the nozzle portion 12 has at least two guiding walls 21 which subdivide the throughflow channel 8 into several part-channels 22. In FIG. 5, these part-channels 22 are shown. The part-channels 22 are delimited by the guiding walls 21 and the side wall 5.

The nozzle portion 12 is configured in a substantially rod-like manner. The nozzle portion 12 or the guiding walls 21 have a length which corresponds to a multiple of the diameter of the throughflow channel.

The flange 20 has a plurality of passages 23, wherein the guiding walls 21 extend away from the flange 20 in such a manner that the passages 23 remain free so that water can pass through the passages 23 through the flange.

From FIG. 3, it can be seen that the fitting member 4 protrudes with a sealing portion 27 of the second coupling portion 10 into a receiving space 28 on the filling valve. Between the sealing portion 27 and the receiving space 28, a seal 29 is arranged. At the outer side the second coupling portion 10 has a union nut 30. The filling valve 3 has a threaded structure 31 onto which the union nut 30 can be screwed.

The hose 2 is as mentioned connected to the first coupling portion 9. The hose 2 has a flexible hose cover 24 which is surrounded at the outer side by an optional protective cover 25. The protective cover 25 is preferably a protective mesh, preferably a metal mesh.

In the embodiment shown, the hose 2 has a cylindrical pressing element 26 which surrounds the hose cover 24 and when present the protective cover 25 at the outer side. The pressing element 26 is pressed against the first coupling portion 9 for secure connection of the hose 2 to the first coupling portion 9.

LIST OF REFERENCE NUMERALS

| | |
|---|---|
| 1 | Fitting |
| 2 | Hose |
| 3 | Filling valve |
| 4 | Fitting member |
| 5 | Side wall |
| 6 | Inlet |
| 7 | Outlet |
| 8 | Throughflow channel |
| 9 | First coupling portion |
| 10 | Second coupling portion |
| 11 | Nozzle element |
| 12 | Nozzle portion |
| 13 | Nozzle-element-side |
| | connection portion |
| 14 | Fitting-member-side |
| | connection portion |
| 15 | Locking flap |
| 16 | Locking recess |
| 17 | Groove |
| 18 | Locking cam |
| 19 | Free end |
| 20 | Flange |
| 21 | Guiding walls |
| 22 | Part-channel |
| 23 | Passages |
| 24 | Hose cover |
| 25 | Protective cover |
| 26 | Pressing element |
| 27 | Sealing portion |
| 28 | Receiving space |
| 29 | Seal |
| 30 | Union nut |
| 31 | Threaded structure |
| M | Centre axis |

1-16. (canceled)

17. A fitting for the connection of a hose to a filling valve, comprising:
a fitting member having a side wall which laterally delimits a throughflow channel which extends from an inlet to an outlet along a centre axis, and having a first coupling portion for connecting the fitting member to the hose and having a second coupling portion for connecting the fitting member to the filling valve, and
a nozzle element which protrudes with a nozzle portion from the inlet or from the outlet into the throughflow channel,
wherein the nozzle element has a nozzle-element-side connection portion and the fitting member has a fitting-member-side connection portion, wherein the two connection portions can be mechanically brought into engagement with each other in such a manner that the nozzle element is connected to the fitting member when a mechanical engagement is established.

18. The fitting according to claim 17, wherein
the engagement is such that the nozzle element is connected to the fitting member in a manner fixed in position with respect to a movement in the direction of the centre axis; or
wherein the engagement is such that the nozzle element is connected to the fitting member in a manner fixed in position with respect to a movement in the direction of the centre axis and in a movable manner with respect to a movement about the centre axis.

19. The fitting according to claim 17, wherein the engagement is such that it counteracts an extraction force acting on the nozzle element; and/or wherein the connection portions are located outside the throughflow channel.

20. The fitting according to claim 17, wherein the connection portions are configured in such a manner that the engagement can be provided by means of a locking connection.

21. The fitting according to claim 17, wherein the nozzle-element-side connection portion has at least one locking flap and wherein the fitting-member-side connection portion has at least one locking recess, wherein the at least one locking flap engages in the at least one locking recess; and/or
wherein the nozzle-element-side connection portion has at least one locking recess and wherein the fitting-member-side connection portion has at least one locking flap, wherein the at least one locking flap engages in the at least one locking recess.

22. The fitting according to claim 21, wherein the locking recess is in the form of a groove which extends completely or partially around the centre axis; and/or wherein the at least one locking flap has a locking cam; and/or wherein the at least one locking flap is orientated substantially parallel with the nozzle portion.

23. The fitting according to claim 21, wherein at least three, in particular at least four, in a particularly preferred manner precisely four locking flaps are arranged and/or
wherein, when a plurality of locking flaps are present, the locking flaps are arranged in a state distributed with regular spacing from each other about the centre axis; and/or
wherein the cross section of the at least one locking flap becomes smaller as the distance from the free end of the respective locking flap becomes smaller; and/or
wherein the nozzle-element-side connection portion has a flange which protrudes away in a state inclined in an angled manner, in particular substantially at right-angles, with respect to the nozzle portion, wherein the at least one locking flap protrudes away from the flange; and/or
wherein the side wall of the fitting member is configured in the region of the fitting-member-side connection location at the outer side with a cylindrical cross section, wherein the at least one locking flap is located at the outer side with respect to the cylindrical cross section and wherein the locking recesses extend into the cylindrical cross section.

24. The fitting according to claim 17, wherein the engagement is provided by means of a bayonet connection or a screw connection.

25. The fitting according to claim 17, wherein the nozzle portion has at least two guiding walls which subdivide the throughflow channel into a plurality of part-channels.

26. The fitting according to claim 17,
wherein the nozzle-element-side connection portion has a flange which protrudes away in a state inclined in an angled manner, in particular substantially at right-angles, with respect to the nozzle portion, wherein the at least one locking flap protrudes away from the flange;
wherein the nozzle portion has at least two guiding walls which subdivide the throughflow channel into a plurality of part-channels; and
wherein the flange has a plurality of passages, wherein the guiding walls extend away from the flange in such a manner that the passages remain free.

27. A fitting arrangement comprising a fitting according to claim 17 and a hose, wherein the hose is connected to the first coupling portion, wherein the hose has a flexible hose cover which is surrounded at the outer side by an optional protective cover, in particular by a protective mesh, preferably by a metal mesh.

28. A fitting arrangement comprising a fitting according to claim 17 and a hose, wherein the hose is connected to the first coupling portion, wherein the hose has a flexible hose cover which is surrounded at the outer side by an optional protective cover, in particular by a protective mesh, preferably by a metal mesh, wherein the hose has a cylindrical pressing element which surrounds the hose cover and, when present, surrounds the protective cover at the outer side, and which for fixed connection of the hose to the first coupling portion is pressed securely against the first coupling portion.

29. A cistern arrangement comprising
a cistern,
a filling valve which is arranged in the cistern and
a fitting arrangement comprising a fitting according to claim 17 and which is arranged in the cistern;
wherein said fitting arrangement comprises a hose, wherein the hose is connected to the first coupling portion, wherein the hose has a flexible hose cover which is surrounded at the outer side by an optional protective cover, in particular by a protective mesh, preferably by a metal mesh, wherein the second coupling portion is connected to the filling valve,
or
wherein said fitting arrangement comprises a hose, wherein the hose is connected to the first coupling portion, wherein the hose has a flexible hose cover which is surrounded at the outer side by an optional protective cover, in particular by a protective mesh, preferably by a metal mesh, wherein the hose has a cylindrical pressing element which surrounds the hose cover and, when present, surrounds the protective cover at the outer side, and which for fixed connection of the hose to the first coupling portion is pressed securely against the first coupling portion.

30. A method for assembling a cistern arrangement, said cistern arrangement comprising
a cistern,
a filling valve which is arranged in the cistern and
a fitting arrangement comprising a fitting according to claim 17 and which is arranged in the cistern;
wherein said fitting arrangement comprises a hose, wherein the hose is connected to the first coupling portion, wherein the hose has a flexible hose cover which is surrounded at the outer side by an optional protective cover, in particular by a protective mesh, preferably by a metal mesh, wherein the second coupling portion is connected to the filling valve,
or
wherein said fitting arrangement comprises a hose, wherein the hose is connected to the first coupling portion, wherein the hose has a flexible hose cover which is surrounded at the outer side by an optional protective cover, in particular by a protective mesh, preferably by a metal mesh, wherein the hose has a cylindrical pressing element which surrounds the hose cover and, when present, surrounds the protective cover at the outer side, and which for fixed connection of the hose to the first coupling portion is pressed securely against the first coupling portion,
wherein prior to the assembly of the fitting arrangement on the filling valve, the nozzle element with the nozzle-element-side connection portion is brought into engagement with the fitting-member-side connection portion in such a manner that the nozzle element is supported securely on the fitting member.
